(19) United States
(12) Patent Application Publication
(10) Pub. No.: US 2005/0022924 A1
(43) Pub. Date: Feb. 3, 2005

(54) Adhesive article for and method of applying a decorative finish to a phone

(76) Inventor: James B. Blackburn, Dorr, MI (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 10/746,842

(22) Filed: Dec. 24, 2003

Related U.S. Application Data
(60) Provisional application No. 60/436,688, filed on Dec. 27, 2002.

(51) Int. Cl. B32B 7/06; B32B 9/00; B32B 33/00; B44C 1/165; H04M 1/02

(52) U.S. Cl. 156/230; 428/40.1; 156/256; 156/252; 455/575.1; 428/41.8; 428/542.8; 379/428.01; 379/433.01; 379/433.11; 379/447

(57) ABSTRACT

A surfacing kit for a cellular phone includes a decorative plastic sheet, with an adhesive layer on one side, and a carrier, which includes a release compound on at least one side. The plastic sheet is mounted on the carrier with the adhesive layer and is removable from the carrier and is configured for placement on a portion of a cellular phone to form a decorative surface on the phone wherein the plastic sheet conforms to the cellular phone to appear as though the plastic sheet forms that portion of the cellular phone.

This application claims priority from U.S. provisional application Ser. No. 60/436,688, filed Dec. 27, 2002, entitled ADHESIVE ARTICLE FOR AND METHOD OF APPLYING A DECORATIVE FINISH TO A PHONE, by Applicant James B. Blackburn, which his incorporated herein by reference in its entirety.

### TECHNICAL FIELD AND BACKGROUND OF THE INVENTION

The present invention relates to an adhesive article that strongly adheres to plastic, such as polypropylene, including reinforced polypropylene, glass-filled or mineral-filled polypropylene, or the like. More particularly, the present invention provides an adhesive article for applying a decorative finish to a housing or casing of an electronic device, such as a phone, personal digital accessory (PDA), a pager, or the like.

There has been an explosion over the last decade in the number and variety of hand-held electronic devices. Personal digital accessories (PDAs), cellular phones, and digital pagers have become household words and household accessories and essential tools for most business people. Even children own and use PDAs, pagers, and cellular phones.

In order to keep the manufacturing costs down, many manufacturers produce a limited number of housing or casing styles, which house the electronics, screens, and keyboards or the like. Furthermore, most of these devices are sold in monochromatic housings or casings—typically black. As a result, it has become hard to distinguish one person's device from another person's device, which is especially true with respect to phones. One way that people customize their phone is through the selection of the ringer tone. But unless the phone is ringing one phone may look just like another phone, especially when made by the same manufacturer. With PDAs there is no current way to distinguish one PDA from another PDA of the same brand other than by storing the PDA in a custom holder.

Consequently, there is an increasing need for people to be able to distinguish their devices from another person's device, especially when the other person owns the same brand of device.

### SUMMARY OF THE INVENTION

Accordingly, the present invention provides a simple way to customize a device in a manner that will permit the owner of the device to personally select the finish of the device and, further, change the finish should the owner grow weary of the finish.

In one form of the invention, a surfacing kit for a cellular phone includes a decorative plastic sheet, which includes an adhesive layer on one side of the plastic sheet and a backing sheet, which includes a release compound on at least one side of the sheet and forms a carrier for the plastic sheet. The plastic sheet is stored on the backing sheet with the adhesive side in contact with the side of the backing sheet with the release compound. The plastic sheet includes at least one closed perimeter opening for placement around a portion of the cellular phone that is not to be decorated by the plastic sheet.

In one aspect, the plastic sheet includes color pigment to form a decorative colored surface on the phone. In addition, the plastic sheet may include at least one region having one or more color pigments to form one color and another region having one or more pigments to form another color. Optionally, the regions may be arranged in one or more geometric patterns to form a geometric decorative surface on the phone or may be arranged to form an image, such as a picture of a person, place, or thing. The color pigments may comprise red, green, and blue pigments, for example, and/or may include metallic pigments, carton fiber pigments, iridescent pigments, or reflective pigments or the like to create visual effects such as color shifting, holographic images, or the like.

According to another form of the invention, a method of applying a decorative surface to a housing of a hand-held electronic device includes providing an adhesive-backed decorative plastic sheet and shaping the plastic sheet to generally conform to the outline of a portion of the housing to be decorated and applying the adhesive side of the plastic sheet to the portion to be decorated.

In one aspect, the shaping is achieved by cutting, for example by a computer controlled cutting assembly, so that the shape of the plastic sheet can very closely match the outline and shape of the portion to be decorated. In addition, one or more openings are cut into the plastic sheet to form a non-decorative area in the plastic sheet for aligning with one or more portions of the housing that are not to be decorated. For example, for a phone, the openings may correspond to the various buttons of the phone and to the screen, and also to the microphone bezel or the like.

In another aspect, two or more plastic sheets are shaped to generally conform to the outline of two or more portions of the housing that are to be decorated and with the adhesive side of the plastic sheets applied to the portions to be decorated.

According to yet other aspects, the plastic sheets are mounted to a backing sheet for storage. For example, the backing sheet has a release agent on at least one side of the backing sheet. The adhesive sides of the plastic sheets contact the release agent so that the plastic sheets can be easily removed from the backing sheet when they are to be applied onto the electronic device.

These and other objects, advantages, purposes, and features of the invention will become more apparent from the study of the following description taken in conjunction with the drawings.

### DETAILED DESCRIPTION OF THE DRAWINGS

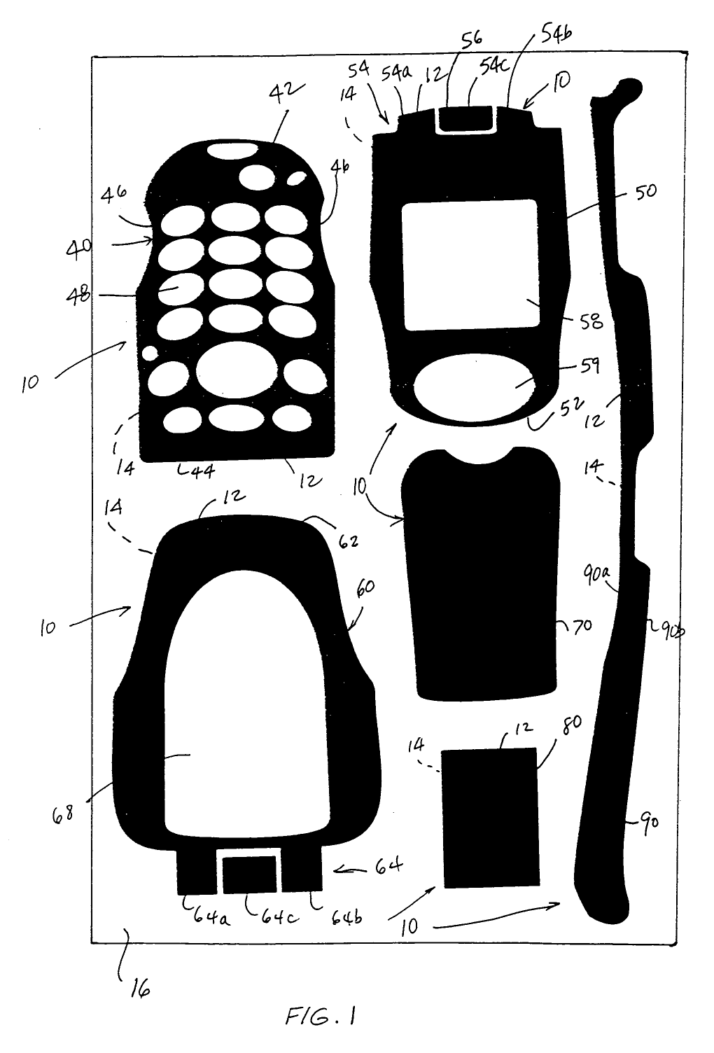

FIG. 1 is a plan view of a kit comprising a plurality of adhesive articles of the present invention mounted on a carrier;

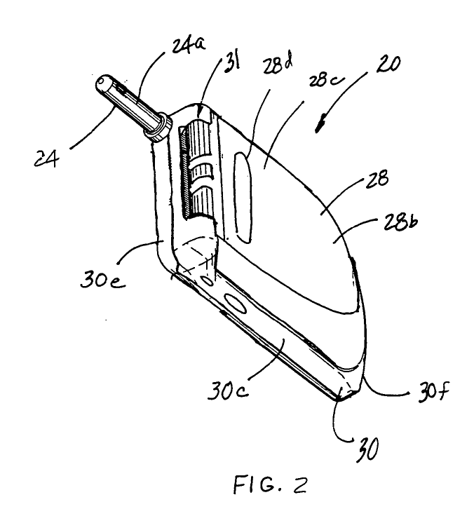

FIG. 2 is a perspective view of a cellular phone;

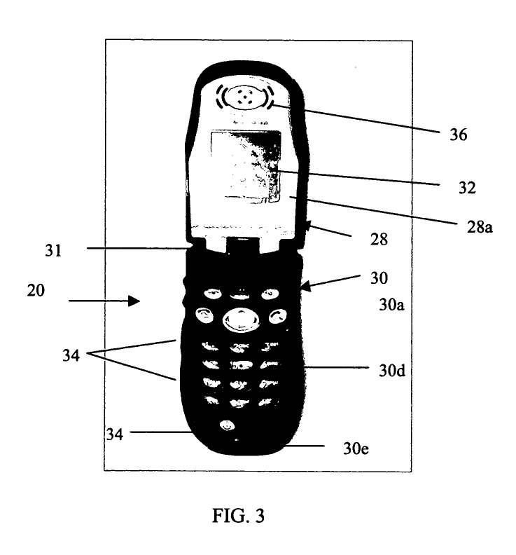

FIG. 3 is a plan view of the cellular phone of FIG. 2 illustrating the phone with its upper housing portion moved to an open or operable position;

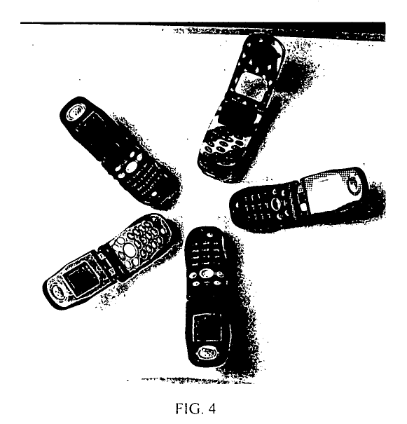

FIG. 4 is a plan view of five cellular phones with the adhesive article of the present invention applied to one or more surfaces of the phones to form decorative surfaces on the respective phones;

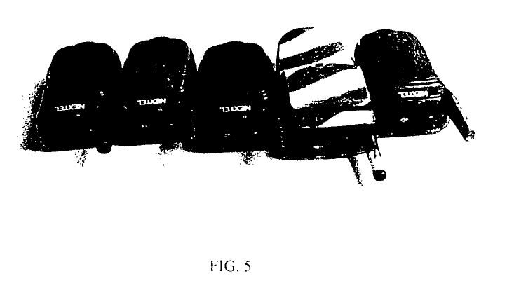

FIG. 5 is a top perspective view of the phones of FIG. 4;

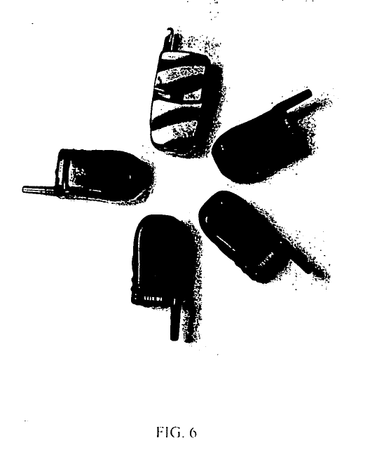

FIG. 6 is a bottom plan view of the phones of FIG. 4 with their upper housing portions moved to their closed or stored positions;

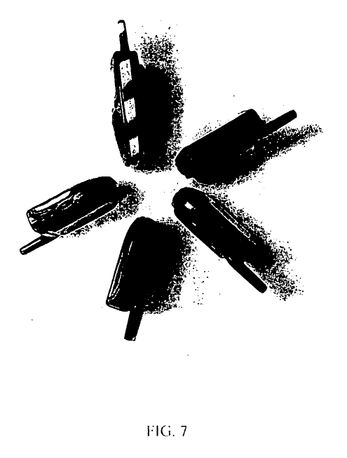

FIG. 7 is a side view of the phones of FIG. 6;

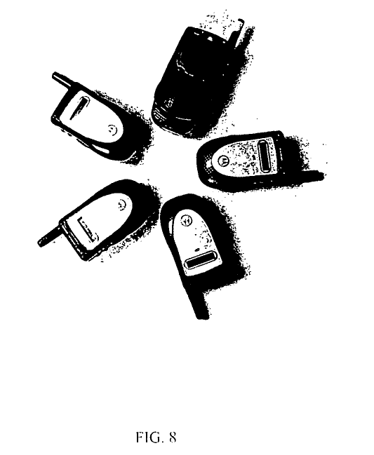

FIG. 8 is a top plan view of the phones of FIG. 4 with their upper housing portions moved to their closed or stored positions;

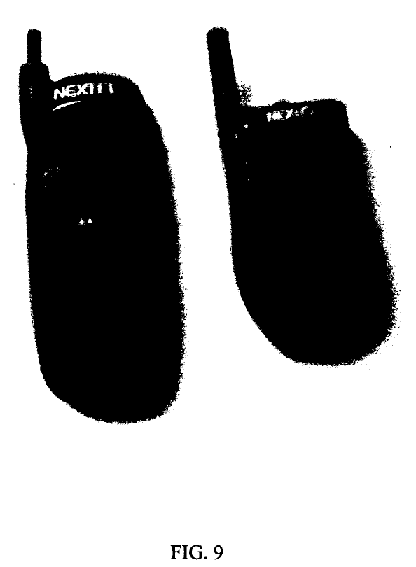

FIG. 9 is a top plan view of two other models of cellular phones that may incorporate the adhesive articles of the present invention;

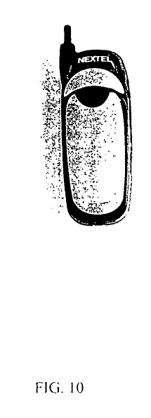

FIG. 10 is a top plan view of one of the phones of FIG. 9, illustrating the adhesive articles of the present invention applied to at least two surfaces of the phone;

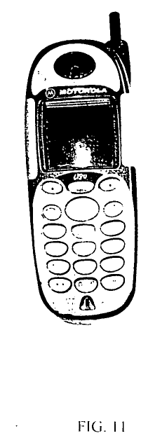

FIG. 11 is a bottom plan view of the phone of FIG. 10 illustrating the adhesive articles of the present invention applied to additional surfaces of the phone of FIG. 10; and

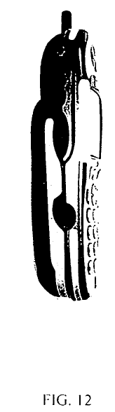

FIG. 12 is a side view of the phone of FIG. 10 illustrating the adhesive articles of the present invention applied to the side of the phone.

### DETAILED DESCRIPTION OF THE PREFERRED EMBODIMENTS

Referring to FIG. 1, the numeral 10 generally designates an adhesive article of the present invention. As will be understood from the summary above and description that follows, adhesive article 10 may have a wide range of shapes and sizes depending on its application. For ease of illustration, reference hereinafter will be made to adhesive articles that are shaped and sized for applying a decorative finish to a cellular phone.

Adhesive article 10 comprises a plastic sheet 12 with an adhesive layer 14. Plastic sheet 12 also includes a decorative layer, which may be formed by printing, including gravure, lithographic, screen, or flexi-graphic printing. Suitable decorative layers may include one or more color pigments, such as RGB (red, green, and blue) pigments, and/or reflective, metallic, carbon fiber, or iridescent pigments, or the like to form colors, patterns, wood grain appearance, holographs, reflective patterns, shade shifters, logos, and pictures, such as of people, places, animals, and things, or the like. The adhesive article is preferably formed from a thin pliable plastic sheet or film so that it can conform to the surface topology of the article to which the adhesive article is to be applied.

Furthermore, adhesive article 10 is preferably mounted on a carrier, such as a backing sheet 16 for storage and handling. Backing sheet 16 comprises a polyester sheet and includes a release agent on at least one side of sheet 16. Adhesive article 10 is mounted on sheet 16 for storage with its adhesive layer in contact with the side of sheet 16 with the release agent to permit plastic sheet 12 to be peeled off backing sheet 16 (or vice versa) when it is ready for application on to the phone. Preferably, backing sheet 16 is removed from the adhesive article rather than the adhesive article removed from the backing sheet, since the adhesive article tends to stretch when being removed from the backing sheet. Suitable plastic sheets and backing sheets are available from AVERY®, SHARPLINE, FDC, and others. It should be understood that other carriers, such as cardboard with a suitable release agent applied thereto, may be used for storing the adhesive articles of the present invention.

After the backing sheet has been removed, the adhesive side of the adhesive article is aligned with the portion of the electronic device to which the adhesive article is to be applied. Optionally, the pressure is applied starting with the center of the adhesive article and working outwardly with slight pressure so that the adhesive article maintains the alignment with the portion of the electronic device to which the article is being applied.

As noted above, the adhesive article of the present invention may be applied to a wide variety of electronic devices. For ease of description and with reference to FIGS. 2 and 3, adhesive article 10 is particularly suitable for applying a decorative finish to one or more surfaces of a cellular phone 20 and also particularly suitable to be supplied as a kit, which may include two or more adhesive articles for surfacing two or more surfaces of a cellular phone. As best seen in FIG. 2, phone 20 is a “flip-style” phone, with a housing 22, an antenna 24, and a battery 26. Antenna 24 is carried by the housing and is used to transmit the RF signals to and from the phone. Battery 26 is detachably coupled to the housing to supply power to the components stored within the phone.

Housing 22 includes upper and lower housing portions 28 and 30, with housing portion 28 being movable between an open position (see FIG. 3) and a closed position (see FIG. 2). The terms “upper” and “lower” are used for exemplary purposes only and not intended to the limit the scope of this invention. Upper housing portion 28 is typically referred to as the flap. In the illustrated embodiment, housing portions 28 and 30 are coupled via hinge 31, which permits housing portion 28 to pivot about housing portion 30 to and from the open and closed positions. Lower housing portion 30 includes an upper or inwardly facing side 30a (FIG. 3), in which keyboard buttons 34 are positioned for controlling the use of the phone, and a lower or outwardly facing side 30b. Upper housing portion 28 similarly includes a downwardly or inwardly facing inner side 28a and an upwardly or outwardly facing side 28b. Inwardly facing side 28a includes an opening in which a screen 32 is positioned and includes a recessed portion 36, which forms a speaker bezel behind which a speaker is positioned. In this manner, housing 22 of phone 20 has at least four major surfaces—outer and inner sides of the upper housing portion 28 and outer and inner sides of lower housing portion 30. In addition, the edge of lower housing portion 30 defines a pair of opposed minor surfaces 30c and 30d and upper and lower end surfaces 30e and 30f, which can also be decorated as will be more fully described below. Other surfaces suitable for decorating include antenna 24, which in the illustrated embodiment includes a cylindrical body 24a at its distal end to which the present invention may also be applied.

Referring again to FIG. 1, adhesive article 10 may be cut into a number of different configurations or shapes. For example, adhesive article 10 may be cut into an adhesive article 40 that is sized and configured so that it can be applied to inner side 30a of lower housing portion 30. As best seen in FIG. 1, article 40 has a generally rectangular shape with an arcuate edge 42 at its upper end and a linear horizontal edge 44 at its lower end to substantially match the upper surface of inner side 30a. As noted above the terms “upper” and “lower” are exemplary terms only and are used to provide a frame of reference with respect to the illustrations of the invention in FIG. 1. The sides of article 40 also include arcuate indentations 46, which adapt the shape of article 40 to conform to the outline of the upper surface of side 30a. In addition, article 40 has a plurality of closed perimeter openings 48, which provide holes or non-decorative areas so that the buttons 34 can be viewed and actuated. The shape of the openings may be varied as needed so that when article 40 is applied to side 30a, article 40 will appear to form side 30a and form a decorative finish on side 30a rather than merely look like a sticker or label or surface decal.

Similarly, adhesive article 10 may be shaped to form an article 50 for decorating inner side 28a of upper housing portion 28. Article 50 is also generally rectangular in shape with an arcuate edge 52 at its lower end and a stepped edge 54 at its upper end, which forms a pair of spaced apart tabs 54a and 54b and an intermediate tab 54c, which form an arcuate edge 56 and are used to decorate hinge 31. Article 50 also includes a large central rectangular opening 58 which aligns with screen 32 and a large oval opening 59, which aligns with microphone bezel 36. Again, openings 58 and 59 are configured to substantially match the perimeter of the opening formed in inner side 28a that surrounds screen 32 and the perimeter of the recessed portion 36 so that article 50 appears to form side 28a and form a decorative finish to side 28a rather than merely look like a sticker or label or surface decal.

Referring again to FIG. 1, article 10 may be cut into articles 60, 70, and 80 for decorating the outwardly facing sides 28b and 30b of upper and lower housing portions 28 and 30 and the antenna 24, respectively. Article 60 is configured for outer side 28b of upper housing portion 28 and has a generally rectangular shape. Article 60 includes an arcuate edge 62 at its upper end and a stepped edge 64 at its lower end, which forms a pair of spaced apart tabs 64a and 64b and an intermediate tab 64c, which are used to decorate the outer surface of hinge 31. Article 60 also includes a large central generally rectangular opening 68 that aligns with the raised surface 28c of outer side 28b of upper housing portion 28. In reference to the particular model of phone illustrated in FIGS. 2 and 3, raised surface 28c has an elongate opening, which surrounds a reduced size screen 28d, and a manufacturer logo. Opening 68 is configured to substantially match the perimeter of the raised portion 28c so that article 60 appears to form side 28b and form a decorative finish on side 28b.

Article 70 is substantially rectangular and is configured for application onto outward side 30b of lower housing portion 30. Article 70 includes a recessed arcuate edge 72 at its upper end to follow the perimeter of the upper surface of outer side 30b of lower housing portion 30.

Article 80 is substantially rectangular and sized to cover cylindrical body 24a of antenna 24.

Optionally, article 10 may be configured as an article 90 for decorating the minor side surfaces of phone 20. Referring to FIG. 1, article 90 comprises an elongated strip of plastic with opposed edges 90a and 90b cut to follow the perimeter of the minor sides 30c, d, e, and f of lower housing portion 30. In addition, edge 90b includes cut-outs or recessed portions to accommodate buttons, lights, and other accessories that may be provided on the sides of housing portion 30.

As would be understood from the foregoing, adhesive articles 40, 50, 60, 70, 80, and 90 are cut for precise placement on the respective surfaces of phone 20 with openings or cut-outs provided to align with screen, buttons, lights, or the like so that when the adhesive article is applied to the phone the article does not interfere with the use of the screens, buttons, lights, etc, and instead provides a decorative finish to the phone on one or more surfaces. As noted above, adhesive article 10 is applied to the phone with light pressure and similarly may be removed with the edge of the film lifted off with the remaining film pulled off the lower portion. However, as noted above, adhesive article 10 is relatively flexible and, further, stretches; therefore, it will not be typically advisable to try to replace the removed article back onto the phone.

Again referring to FIG. 1, adhesive article 10 may be provided in the form of a kit with a number of articles, such as 50, 60, 70, 80, and 90, supplied on a single backing sheet. The articles are preferably computer cut to fit so that when applied they appear to form the surface of the phone and provide the decorative finish to the phone.

As discussed above, the adhesive articles of the present invention are useful and can be applied as decorative finishes to a variety of devices, such as cellular phones, PDA's, pagers, or the like. Reference is made to FIGS. 4-12 for other examples of phones to which the present invention may be applied and also for examples of the types of finishes that can be applied using the present invention.

Therefore, it will be understood that the embodiments shown in the drawings and described above are merely for illustrative purposes only, and are not intended to limit the scope of the invention, which is defined by the claims which follow as interpreted under the principles of patent law including the doctrine of equivalents.

1. A surfacing kit for a cellular phone, said kit comprising:
a flexible decorative plastic sheet, said plastic sheet including an adhesive layer on one side of said plastic sheet;
a carrier, said carrier including a release compound on a side of said carrier; and
said plastic sheet being mounted on said carrier with said adhesive layer in contact with said side of said carrier, and said plastic sheet being removable from said carrier and being configured for placement on a portion of a cellular phone to form a decorative surface on the phone wherein said plastic sheet conforms to the portion of the cellular phone to appear as though said plastic sheet forms the portion of the cellular phone.

2. The surfacing kit according to claim 1, wherein said plastic sheet includes at least one closed perimeter opening for placement around a portion of the cellular phone that is not to be decorated by said plastic sheet.

3. The surfacing kit according to claim 2, wherein said plastic sheet includes a plurality of closed perimeter openings for placement around portions of the cellular phone that are not to be decorated by said plastic sheet.

4. The surfacing kit according to claim 1, wherein said plastic sheet includes at least one pigment to form a decorative surface on the phone, said pigment comprising a pigment chosen from a color pigment, a metallic pigment, a carbon fiber pigment, an iridescent pigment, and a reflective pigment.

5. The surfacing kit according to claim 1, wherein said plastic sheet includes at least one region having at least one pigment to form one decorative region and at least one other region having at least one other pigment to form another decorative region.

6. The surfacing kit according to claim 5, wherein said regions are arranged in one or more geometric patterns to form a geometric decorative surface on the phone.

7. The surfacing kit according to claim 5, wherein said regions are arranged to form an image chosen from a picture of a person, a picture of a place, and a picture of an object.

8. The surfacing kit according to claim 5, wherein said regions are arranged to create a visual effect comprising at least one chosen from a color shifting effect and a holographic image effect.

9. The surfacing kit according to claim 1, further comprising a second flexible decorative plastic sheet, said second flexible decorative plastic sheet including an adhesive layer on one side of said second flexible decorative plastic sheet, said second flexible decorative plastic sheet being mounted on said carrier, and said second flexible decorative plastic sheet being removable from said carrier and being configured for placement on another portion of the cellular phone to form a second decorative surface on the phone.

10. A method of applying a decorative surface to a housing of a hand-held electronic device, said method comprising the steps of:
providing a flexible adhesive-backed decorative plastic sheet;
shaping the plastic sheet to generally conform to an outline of a first portion of the device;
providing at least one closed perimeter opening in the plastic sheet for aligning with a second portion that is not to be decorated by the plastic sheet within the first portion of the device;
generally aligning the closed perimeter opening of the plastic sheet with the second portion; and
applying the adhesive side of the plastic sheet to the first portion of the device for decorating the device.

11. The method according to claim 10, wherein said shaping is achieved by cutting.

12. The method according to claim 10, wherein said providing comprises cutting said closed perimeter opening into the plastic sheet.

13. The method according to claim 12, wherein said providing comprises providing a plurality of closed perimeter openings to align with a plurality of portions of the device within the first portion that are not to be decorated with the plastic sheet.

14. The method according to claim 10, wherein said providing includes providing at least two adhesive-backed decorative plastic sheets and shaping the plastic sheets to generally conform to outlines of two portions of the device.

15. The method according to claim 10, wherein said providing includes providing a flexible adhesive-backed decorative sheet mounted to a backing sheet, further comprising removing the plastic sheet from the backing sheet before said applying.

16. A surfacing kit for a hand-held device, said kit comprising:
a flexible decorative plastic sheet, said plastic sheet including an adhesive layer on one side of said plastic sheet, said sheet having at least one closed perimeter opening;
a carrier, said carrier including a release compound on a side of said carrier; and
said plastic sheet being mounted on said carrier with said adhesive layer in contact with said side of said carrier, and said plastic sheet being removable from said carrier and being configured for placement on a first portion of a cellular phone with said opening aligning with a second portion within the first portion to form a decorative surface on the phone where said plastic sheet conforms to the device to appear as though said plastic sheet forms a portion of the device.

17. The surfacing kit according to claim 16, wherein said plastic sheet includes at least one pigment to form a decorative surface on the phone, said pigment comprising a pigment chosen from a color pigment, a metallic pigment, a carbon fiber pigment, an iridescent pigment, and a reflective pigment.

18. The surfacing kit according to claim 17, wherein said plastic sheet includes at least one region having at least one pigment to form one decorative region and at least one other region having at least one other pigment to form another decorative region.

19. The surfacing kit according to claim 18, wherein said regions are arranged to form at least one chosen from an image and a geometric pattern.

20. The surfacing kit according to claim 16, further comprising a second flexible decorative plastic sheet, said second flexible decorative plastic sheet including an adhesive layer on one side of said second flexible decorative plastic sheet, said second flexible decorative plastic sheet being mounted on said carrier, and said second flexible decorative plastic sheet being removable from said carrier and being configured for placement on another portion of the device to form a second decorative surface on the device.
